(19) United States
(12) Patent Application Publication
(10) Pub. No.: US 2007/0138875 A1
(43) Pub. Date: Jun. 21, 2007

(54) Concept E

(76) Inventor: Moses Ewart Hall, Boca Raton, FL (US)

Correspondence Address: Moses Ewart Hall, 5930 2A Winamac Lake Drive, Mishawaka, IN, 46545, US

(21) Appl. No.: 11/344,568

(22) Filed: Jul. 19, 2006

(51) Int. Cl. G09B 23/18; G09B 25/02

(52) U.S. Cl. 310/1

(57) ABSTRACT

The area to which this invention pertains is the creation of electric energy from the force of gravity. Through the use of electromagnetic generators and a gravity drive system consisting of two opposite rotating weights and an electric motor to create cheap, affordable, abundant, pollution free electricity. This is the idea on which the the invention is built on. But what must also be considered is how this idea will be implemented and it's effects on the relationship between countries and on the environment.

### CROSS REFERENCE TO RELATED APPLICATIONS

SYSTEMS CONCERNING THE USE OF ELECTRICITY TO EXTRACT HYDROGEN FROM WATER MOLECULES

SYSTEMS CONCERNING THE CREATION OF A HYDROGEN INFRASTRUCTURE

SYSTEMS CONCERNING THE INTERNAL COMBUSTION ENGINE AND IT'S CONVERSION TO THE USE OF HYDROGEN

SYSTEMS CONCERNING THE ELECTRIC GRID AND IT'S INFRASTRUCTURE AND RELATED SYSTEMS

A brief description on the creation of the idea and resulting invention

Due to the lack of funding and resource available to me at the time. I decided on a more modest approach to solving this difficult problem. to first simplify the problem and in doing so it would only require me to invent a simple solution. After studying every engine design and power source ever invented. I reached the conclusion that most if not all could be based on two simple principles.

First

### The ability to produce some form of energy

Second

### A force to drive said ability

After searching for the solution to these two principles I decided to use electromagnetism as the ability to produce energy in the form of electricity and gravity as the force that would drive the said ability.

### Equipment Specification

Two electromagnetic generators rated at 12600 running watts output each.

### Two electric motors which will consume 70% of both generators combined output rated at 17640 watts consumption each.

Ratio of gear from electric motor to generator is a variable dependent on speed of motor allowing generators to spin at 3400 rotation per minute.

### Ratio of gears from motors and generators to weights is one 360° rotation of the weights to 55-360° rotation of motors and or generators.

Determining size of weights is dependent on the lenght of the arm they are placed on in relation to the pivot on which it turns.

### Requiring each weight to over come the load placed on them by the motors and generators with the least amount of mass as possible.

004 Computer control system consist of eight sensors placed on each electric motor to track both the position of both weight in relation to each other as well as speed of motors.

### Switches to transfer electricity between motors.

### Programmed CPU managing generators output to electric motors energy input according to speed of motors and positions of weights.

battery system requires enough energy to turn electric motors for about 3-4 minutes before generators come online and batteries turned off.

### Gravity Control System

As the computer control system draws energy from the battery supplying electricity to both electric motors which then turn generators up to the required 3400 RPMS speed. The battery is switched off and the load is transfer to the generators.

As battery is switched off weight #1 is at 0° being pulled by gravity to 180° creating motion that is used to turn electric motor and generator #1 which along with generator #2 sends 70% of their total output to electric motor #2 which then turns generator #2 and weight #2.

003 Turning weight #2 from 180° to 0°. Note that both weights are in opposite 180° cycles. And as weight #2 reaches 0° electricity is switched off and gravity takes over pulling weight #2 from 0° to 180° creating motion to turn motor and generator #2. Electricity is now switched to motor #1 and weight #1 which is now at 180°.

70% of both generators output is again used by motor #1 to lift weight #1 from 180° to 0°. Electricity is then switched off from motor #1 as gravity again begins to affect weight #1. Electricity is then switched back to motor #2 and weight #2 which is now at 180° again. These two cycles repeat themselves over and over again.
Note that the spinning inner core of the generators and that of the weights adds a force of momentum along with that of the electric motors power to keep both generators producing electricity to power motors and keep weights turning even when cycles are at the negative 180° to 0°.

### Design Variation

Both electric motors can be replaced by one single electric motor in which both weight #1 and weight #2 would be connected directly to both electric generators.

The electric motor would then use a mechanical means by which to engage both weight #1 and #2 from 180° to 0° and disengage from 0° to 180°. Note that the motor is supplied by 70% of both generators output as it engages and disengages weights at their opposite cycles.

The design can also be made more efficient by replacing the metal lubricated bearings with magnetic repulsion bearings system. And by insulating the electric generators and motors inner core then lowering the inner pressure inside the motors and generators inner cylinders creating less resistance for the core to travel through.

### The Gravity Drive System

The system can be replaced by any mechanical means that would be able to simulate the effects of gravity.

### A spring load system

### A hydrolic liquid or air system

### A piston styled gravity drive system

### Electric Motors System

The 360° rotation of the motor can be replaced with an attraction and repulsion configuration type system.

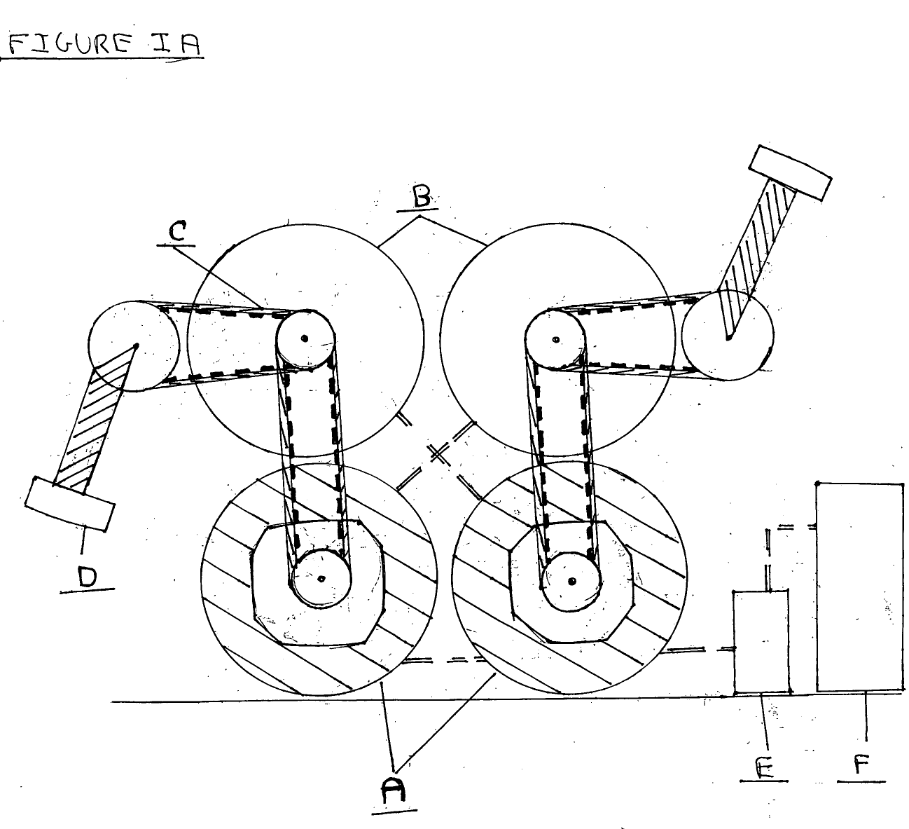

FIG. 1 A

Where A represents the two electric generators

B—electric motors

C—gear systems

D—Gravity drive system

E—Computer control system

F—Battery system

FIG. 1 A represents the basic design of the concept E and gravity drive system in it's 180° opposite cycles.

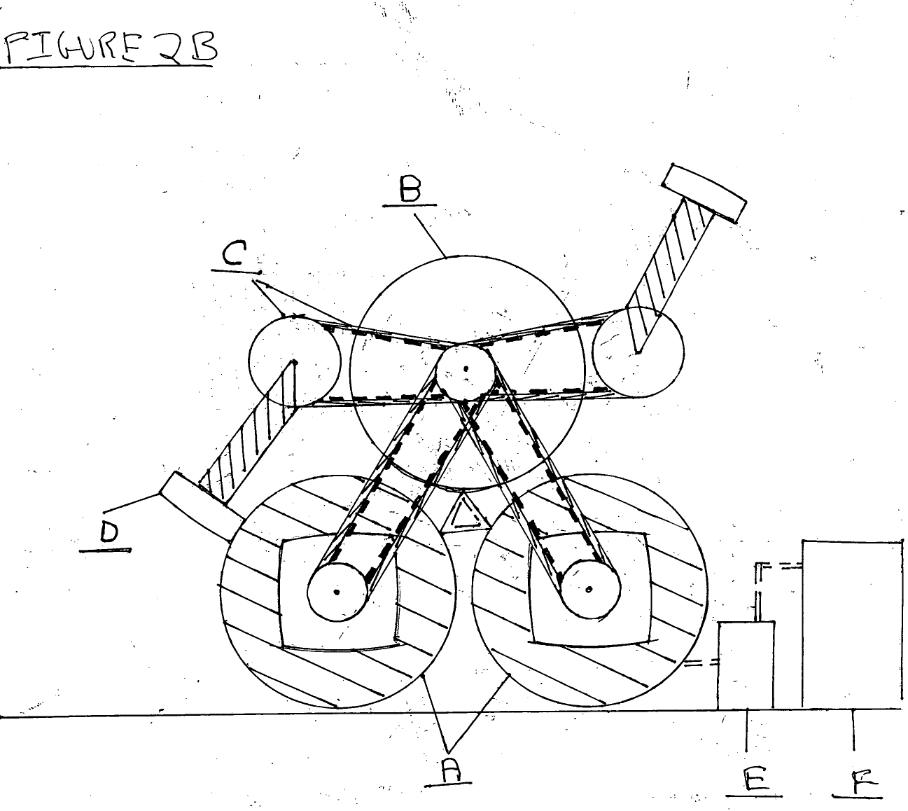

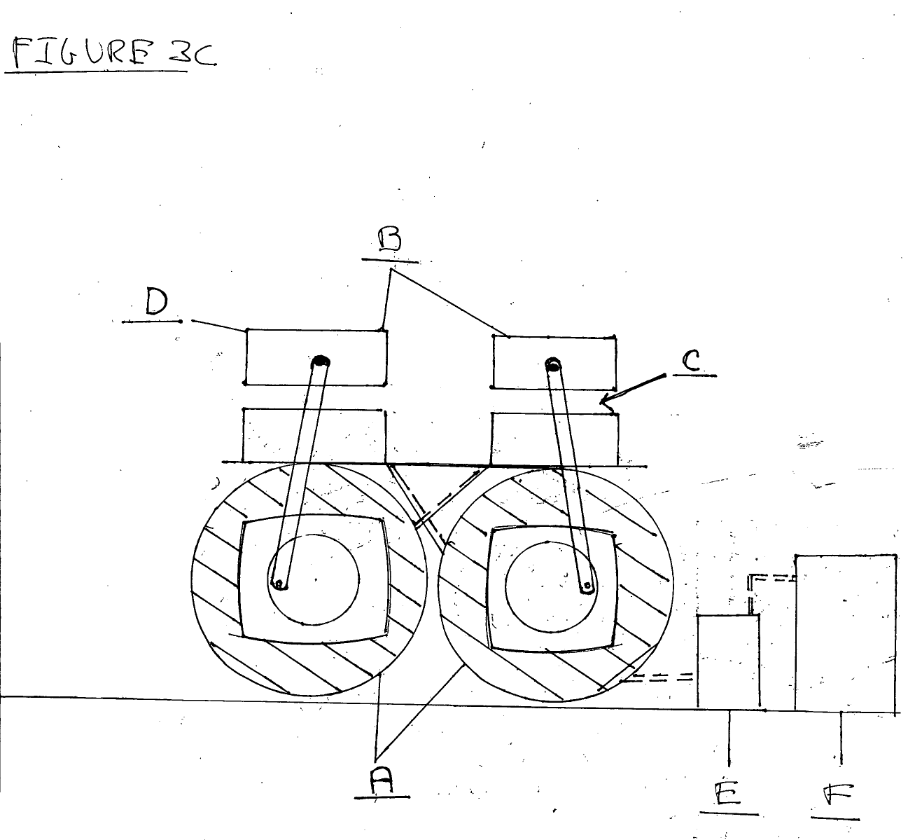

FIG. 2 B

Where A represents the two electric generators

B—electric motors

C—gear system and mechanical system used to engage and disengage gravity drive system

D—gravity drive system

E—computer control system

F—battery

FIG. 2 B represents a design variation where both electric motors are replaced with only one. Where the gravity drive system is connected directly to the electric generators and the electric motors is also connected to generators but uses a mechanical means to engage and disengage both weights at their opposite cycles.

FIG. 3 C

Where A represents two electric generators

B—electric motors

C—repulsion and attraction configured electric motor

D—gravity drive system

E—computer control system

F—battery

Where FIG. 3 C represents a design variation where the 360° rotation of the electric motors is replaced with an up and down—repulsion and attraction configuration. And where the mobile portion of the electric motors is also used as the gravity drive system.

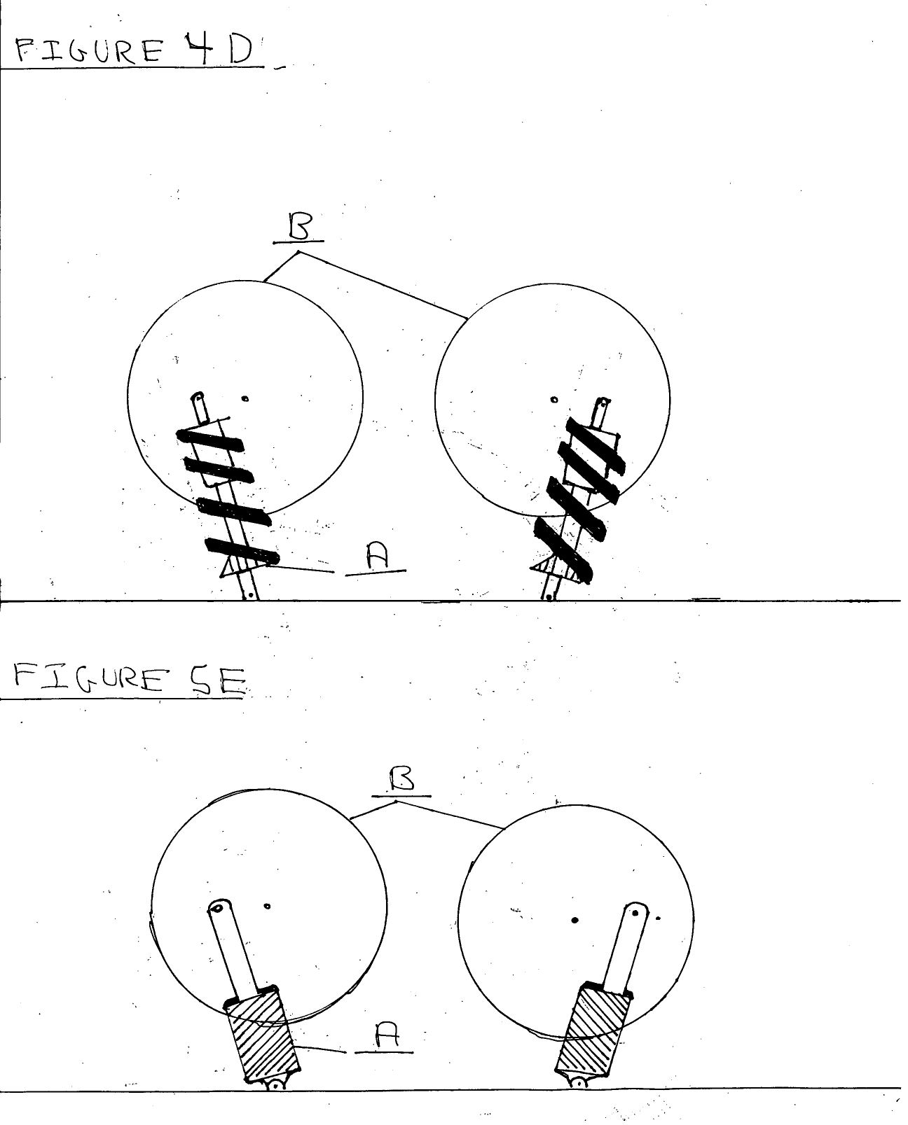

FIG. 4 D

Where A represents a spring tension drive system

B—electric motors

Where FIG. 4 D represents the replacement of the gravity drive system with a spring tension system.

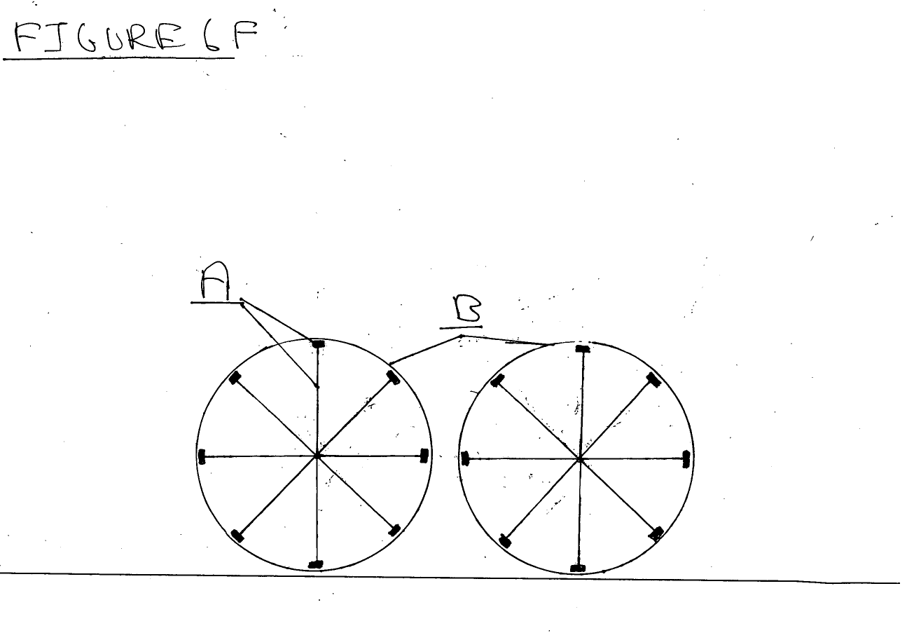

FIG. 5 E

Where A represents a liquid or air hydrolic drive system

B—electric motors

Where FIG. 5 E represents the replacement of the gravity drive system with a hydrolic liquid or air drive system

FIG. 6 F

Where A represents eight motion sensors placed on the electric motors to track speed of motors and position of weights in relation to each others.

B—electric motors

1. A system consisting of two identical electromagnetic generators and two identical electric motors which will consume 70% of both generators output.
Both electric motors can be replaced by only one that will use a mechanical means to engage both weights from 180° to 360° and disengage both weights from 0° to 180°.

2. Gravity drive system which consist of two identical weights of equal mass. They would be connected to two arms of a given equal length that would rotate on a given pivot. The weights and arms system would be connected to the electric motors and generators via a gear system.

3. Refering to claim number two. The mass of both weights and the lengths of the two arms which they are connected to is determined not only by the relationship between the mass of the weights to the lengths of the arms but also by the amount of friction created by the electric motors, generators and mechanical gear system. This friction has to be overcome in order for gravity's effect on the weights to produce motion from 0° to 180°.

4. Gravity drive system principles. Both weights must operate in syncronized opposite 180° cycles.
However they rotate independently of any mechanical means of each other. In which weight #1 would be connected to motor and generator #1 and weight #2 would be connected to motor and generator #2.

5. Gravity drive system principles.
Both weights create motion and electricity from 0° to 180° in their opposite syncronized cycles. And both weights require electricity from generators to power electric motors to lift weights back up to 0° from 180° in their opposite rotating cycles.

6. Computer control system
Consist of eight motion sensors placed equally apart in a 360° circular configuration on the electric motors.
Consist of variable resistors and electric switches.
Consist of a programmed chip in a system used to manage electricity output of generators to electric motors input

7. Principles of the computer control system.
Consist of sensors used to track speed of both motors and track position of both weights in relation to each others opposite cycles.
Consist of variable resistors and switches to vary electricity to motors to control position of weights.
Consist of a programmed chip to control variable resistors and switches to control electricity to motors. And control of generators output to motors in put to indirectly control position of weights.

8. Design variation on gravity drive system. Refering to claim number two. Replacing both weights and the principles of gravity's effect on the system with a spring tension system. Two springs of equal tension connected to two arms of equal lengths. Tension to contract and create motion from 0° to 180°.

9. Replacing both weights and the principles of gravity's effect on the system with a hydrolic liquid or air system. In which two equal hydrolic cylinders are connected to both arms and made to create motion from 0° to 180°.

10. Where the 360° rotation of the electric motors are replaced with an attraction and repulsion up and down configuration Where an arm is connected to the center of the mobile portion of the electric motor and connected off center to the generators to produce a 360° rotation at the generators.

11. Reduction of friction
Insulating the inner core of motors and generators then lowering the air pressure in the motors and generators inner cylinders.
Replacing metal lubricated bearings with a magnetic repulsion system.
